(19) United States
(12) Patent Application Publication
(10) Pub. No.: US 2016/0249162 A1
(43) Pub. Date: Aug. 25, 2016

(54) COMMUNICATION DEVICE AND COMMUNICATION METHOD

(71) Applicants: Ryusuke MAYUZUMI, Kanagawa (JP); Shintaro KAWAMURA, Kanagawa (JP); Masaru KURODA, Tokyo (JP); Kohki OHHIRA, Tokyo (JP); Hiroki SUGINO, Kanagawa (JP)

(72) Inventors: Ryusuke MAYUZUMI, Kanagawa (JP); Shintaro KAWAMURA, Kanagawa (JP); Masaru KURODA, Tokyo (JP); Kohki OHHIRA, Tokyo (JP); Hiroki SUGINO, Kanagawa (JP)

(73) Assignee: RICOH COMPANY, LTD., Tokyo (JP)

(21) Appl. No.: 15/014,263

(22) Filed: Feb. 3, 2016

(30) Foreign Application Priority Data
Feb. 24, 2015 (JP) 2015-034421

(51) Int. Cl. H04W 4/02; H04W 72/04; H04W 4/00

(52) U.S. Cl. CPC H04W 4/021; H04W 4/008; H04W 72/048

(57) ABSTRACT

A communication device includes a first communication unit to execute radio communication by a first communication scheme allowing execution of the radio communication within a first communication range; a second communication unit to execute radio communication by using a second communication scheme allowing execution of the radio communication within a second communication range; a setting information retrieval unit to obtain, upon detecting that the communication device is within a predetermined area, setting information for establishing the radio communication by the first communication scheme; and a disconnection processing unit to disconnect radio communication with another communication device, wherein the first communication unit executes radio communication with the other communication device that obtains the setting information, and wherein, upon detecting that the communication device is not located within the second communication range, the disconnection processing unit disconnects the radio communication with the other communication device.

### BACKGROUND OF THE INVENTION

1. Field of the Invention

The present invention relates to a communication system.

2. Description of the Related Art

A technique has been known such that, for connecting a device to an ad-hoc network that is formed of a radio network, such as a wireless local area network (LAN), authentication is automatically executed so as to obtain connection permission by using short-range radio communication with a communication area that is smaller than that of the ad-hoc network.

A technique for establishing a network connection between a communication device and a receiving device has been known such that, for receiving, by the receiving device, a content that is transmitted by the communication device, the receiving device approaches to an authentication device, which is different from the communication device, to establish the network connection (cf. Patent Document 1 (Japanese Unexamined Patent Publication No. 2013-242925), for example).

### SUMMARY OF THE INVENTION

For a case where a device is located in a communication area of short range radio communication, connection permission may be automatically provided for the device, even if the device is located at a position that may not be viewed due to a shield, such as a wall, which can be a security problem of a radio network.

In a communication system in which connection permission for connecting a device to an ad-hoc network, which is formed of a radio network, can be obtained from a network other than the ad-hoc network, it is desirable to enhance security for the radio communication network.

According to an aspect of the present invention, there is provided a communication device including a first communication unit configured to execute radio communication by using a first communication scheme, the first communication scheme allowing the radio communication to be executed within a first communication range; a second communication unit configured to execute radio communication by using a second communication scheme, the second communication scheme allowing the radio communication to be executed within a second communication range; a setting information retrieval unit configured to obtain, in response to detecting that the communication device is located within a predetermined area, setting information for establishing the radio communication by using the first communication scheme; and a disconnection processing unit configured to disconnect radio communication that is established, by the first communication unit, with another communication device, wherein the first communication unit is configured to execute, by using the first communication scheme, radio communication with the other communication device that obtains the setting information, and wherein, upon detecting that the communication device is not located within the second communication range, the disconnection processing unit is configured to disconnect the radio communication that is established with the other communication device by the first communication unit.

According to another aspect of the present invention, there is provided a communication method to be executed by a communication device including a first communication unit configured to execute radio communication by using a first communication scheme, the first communication scheme allowing the radio communication to be executed within a first communication range; and a second communication unit configured to execute radio communication by using a second communication scheme, the second communication scheme allowing the radio communication to be executed within a second communication range, wherein the communication method includes a step of obtaining, in response to detecting that the communication device is located within a predetermined area, setting information for establishing the radio communication by using the first communication scheme; a step, by the first communication unit, of executing, by using the first communication scheme, radio communication with another communication device that receives the setting information; and a step of disconnecting, upon detecting that the communication device is not located within the second communication range, the radio communication that is established with the other communication device by the first communication unit.

According to an embodiment of the present invention, in a communication system in which connection permission for connecting a device to an ad-hoc network, which is formed of a radio network, can be obtained from a network other than the ad-hoc network, security can be enhanced for the radio communication network.

Other objects, features and advantages of the present invention will become more apparent from the following detailed description when read in conjunction with the accompanying drawings.

### BRIEF DESCRIPTION OF THE DRAWINGS

FIG. 1 is a diagram showing a configuration example of a radio communication system according to an embodiment;

FIG. 2 is a diagram showing hardware configuration examples of a first radio communication device and a second radio communication device according to the embodiment;

FIG. 3 is a diagram showing a hardware configuration example of a third radio communication device according to the embodiment;

FIG. 4 is a sequence chart illustrating an operation of the radio communication system according to the embodiment;

FIG. 5 is a sequence chart illustrating an operation of the radio communication system according to the embodiment;

FIG. 6 is a diagram showing a hardware configuration example (version 1) of an information processing device according to the embodiment;

FIG. 7 is a functional block diagram (version 1) showing the radio communication system according to the embodiment;

FIG. 8 is a diagram showing a hardware configuration example (version 2) of the information processing device according to the embodiment;

FIG. 9 is a diagram showing a hardware configuration example (version 3) of the information processing device according to the embodiment;

FIG. 10 is a functional block diagram (version 2) showing the radio communication system according to the embodiment;

FIG. 11 is a diagram showing a hardware configuration example (version 4) of the information processing device according to the embodiment;

FIG. 12 is a functional block diagram (version 3) showing the radio communication system according to the embodiment;

FIG. 13 is a diagram showing a hardware configuration example (version 5) of the information processing device according to the embodiment; and

FIG. 14 is a functional block diagram (version 4) showing the radio communication system according to the embodiment.

### DETAILED DESCRIPTION OF THE PREFERRED EMBODIMENTS

Next, an embodiment of the present invention is described by referring to the accompanying drawings. The embodiment that is described below is merely an example, and embodiments to which the present invention is applied are not limited to the embodiment that is described below. Note that, in all the figures for describing the embodiment, the same reference numerals may be attached to components having the same functions, and thereby duplicate description may be omitted.

### Overview

### Radio Communication System

In a radio communication system according to the embodiment, within a first radio communication area for executing communication by a first communication scheme (e.g., a wireless local area network (LAN)), a radio network with a second radio communication area that is smaller than the first radio communication area can be formed by a second radio communication scheme (e.g., a personal area network (PAN)). Furthermore, the radio communication system can form a predetermined area. A device can communicate in the wireless LAN and the wireless PAN, and upon entering the predetermined area, the device can obtain setup information, such as authentication information and setting information, which is set for the wireless LAN. The device can be connected to the wireless LAN by using the setup information (e.g., the authentication information and the setting information) that is obtained in the predetermined area. Furthermore, upon exiting from the wireless PAN, the device can execute a process for disconnecting the communication with the wireless LAN. Namely, the device is allowed, by using the setup information that is obtained in the predetermined area, to communicate through the wireless LAN within a restricted radio communication area of the first radio communication area of the wireless LAN such that the restricted radio communication area overlaps the second radio communication area of the wireless PAN.

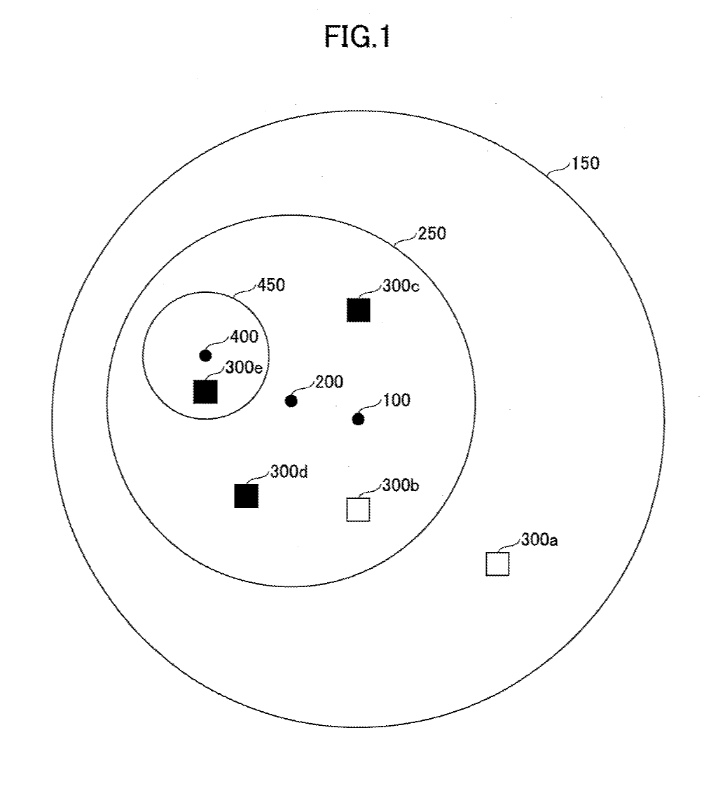

FIG. 1 shows a radio communication system according to the embodiment. The radio communication system according to the embodiment may include a first radio communication device 100; a second radio communication device 200; third radio communication devices 300a-300e; and an information processing device 400. Hereinafter, any third radio communication device among the third radio communication devices 300a-300e may be represented by “the third radio communication device 300.”

The first radio communication device 100 can be installed in an access point or a radio base station, and the first radio communication device 100 can form a first radio communication area 150 by a first radio communication scheme (e.g., the wireless LAN). The second radio communication device 200 can be installed in an access point or a radio base station, and the second radio communication device 200 can form, within the first radio communication area 150, a second radio communication area 250 that is smaller than the first radio communication area 150 by a second radio communication scheme, such as short range radio communication (e.g., Bluetooth (registered trademark)). In the example that is shown in FIG. 1, the second radio communication area 250 is included in the first radio communication area 150.

The third radio communication device 300 can be installed in a mobile communication device, such as a smartphone, a tablet terminal, a mobile game device, and a laptop personal computer (PC); and the third radio communication device 300 can wirelessly communicate with the first radio communication device 100 and the second radio communication device 200. Note that, in response to detecting that any one of the third radio communication devices 300a-300e enters a predetermined area 450, the one of the third radio communication devices 300a-300e can obtain, from the information processing device 400, setup information (e.g., authentication information and setting information) that can be used for establishing a connection with the first radio communication device 100. In response to detecting that the one of the third radio communication devices 300a-300e is located at an overlap area where the first radio communication area 150 overlaps the second radio communication area 250, the one of the third radio communication devices 300a-300e can execute a connection process with the first radio communication device 100 by using the setup information that is obtained from the information processing device 400.

The information processing device 400 can be installed in a mobile device, such as a smartphone, a tablet terminal, a mobile game device, and a laptop personal computer (PC); and the information processing device 400 can communicate with the third radio communication device 300. Note that, in response to detecting that the third radio communication device 300 enters the predetermined area 450, the information processing device 400 may allow the third radio communication device 300 to obtain the setup information.

In the example that is shown in FIG. 1, the overlap area is the same as the second radio communication area 250 because the second radio communication area 250 is included in the first radio communication area 150. In addition, the predetermined area 450 is included in the second radio communication area 250.

Though the third radio communication device 300a is located within the first radio communication area 150, the third radio communication device 300a may not communicate with the first radio communication device 100 because the third radio communication device 300a is not located in the overlap area. Though the third radio communication device 300b is located within the overlap area, the third radio communication device 300b may not execute a connection process with the first radio communication device 100 because the third radio communication device 300b has not obtained the setup information from the information processing device 400 that covers the predetermined area 450. The third radio communication devices 300c and 300d are located within the overlap area, and the third radio communication devices 300c and 300d obtain the setup information from the information processing device 400. Thus, the third radio communication devices 300c and 300d can execute a connection process with the first radio communication device 100. The third radio communication device 300e can obtain the setup information, and execute a connection process with the first radio communication device 100 because the third radio communication device 300e is located within the predetermined area 450.

Hereinafter, a case is described as an example where a wireless LAN is adopted as the first radio communication scheme, and Bluetooth (registered trademark) is adopted as the second radio communication scheme. Here, contactless radio (near field communications (NFC)) may be adopted as the second radio communication scheme.

### Hardware Configuration According to the Embodiment

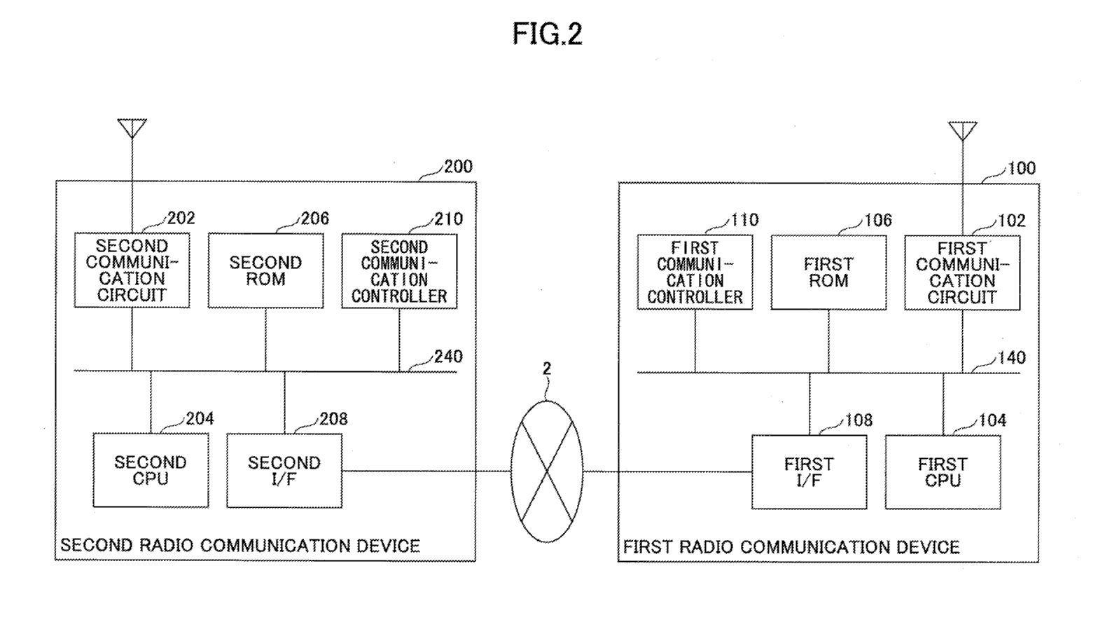

Next, a hardware configuration according to the embodiment is described. FIG. 2 is a diagram showing hardware configuration examples of the first radio communication device 100 and the second radio communication device 200 according to the embodiment. As shown in FIG. 2, the first radio communication device 100 according to the embodiment may include a first communication circuit 102 for transmitting and receiving radio signals through an antenna in accordance with a standard of the first communication scheme; and a first central processing unit (CPU) 104 for controlling operations of the whole first radio communication device 100. Additionally, the first radio communication device 100 may include a first read-only memory (ROM) 106 that stores various types of data, such as a program for the first radio communication device that is used for driving the first CPU 104, transmit data, and so forth. Additionally, the first radio communication device 100 may include a first interface (I/F) 108 for executing data transmission through the communication network 2; and a first communication controller 110 for operating the first radio communication device 100 as an access point of the first radio communication scheme. The first communication circuit 102, the first CPU 104, the first ROM 106, the first I/F 108, and the first communication controller 110 can be connected by a first bus 140. The program for the first radio communication device 100 may be stored in a computer readable recording medium, such as a storage medium, as a file in an installable format or in an executable format, and the program for the first radio communication device 100 may be distributed.

The second radio communication device 200 according to the embodiment may include a second communication circuit 202 for transmitting and receiving radio signals through an antenna in accordance with a standard of the second communication scheme; and a second CPU 204 for controlling operations of the whole second radio communication device 200. Additionally, the second radio communication device 200 may include a second read-only memory (ROM) 206 that stores various types of data, such as a program for the second radio communication device 200 that is used for driving the second CPU 104, transmit data, and so forth. Additionally, the second radio communication device 200 may include a second interface (I/F) 208 for executing data transmission through the communication network 2; and a second communication controller 210 for operating the second radio communication device 200 as an access point of the second radio communication scheme. The second communication circuit 202, the second CPU 204, the second ROM 206, the second I/F 208, and the second communication controller 210 can be connected by a second bus 240. The program for the second radio communication device 200 may be stored in a computer readable recording medium, such as a storage medium, as a file in an installable format or in an executable format, and the program for the second radio communication device 200 may be distributed.

Here, the first radio communication device 100 and the second radio communication device 200 can be configured as a single radio communication device. In this case, the first I/F 108 and the second I/F 208 may be directly connected without passing through the communication network 2.

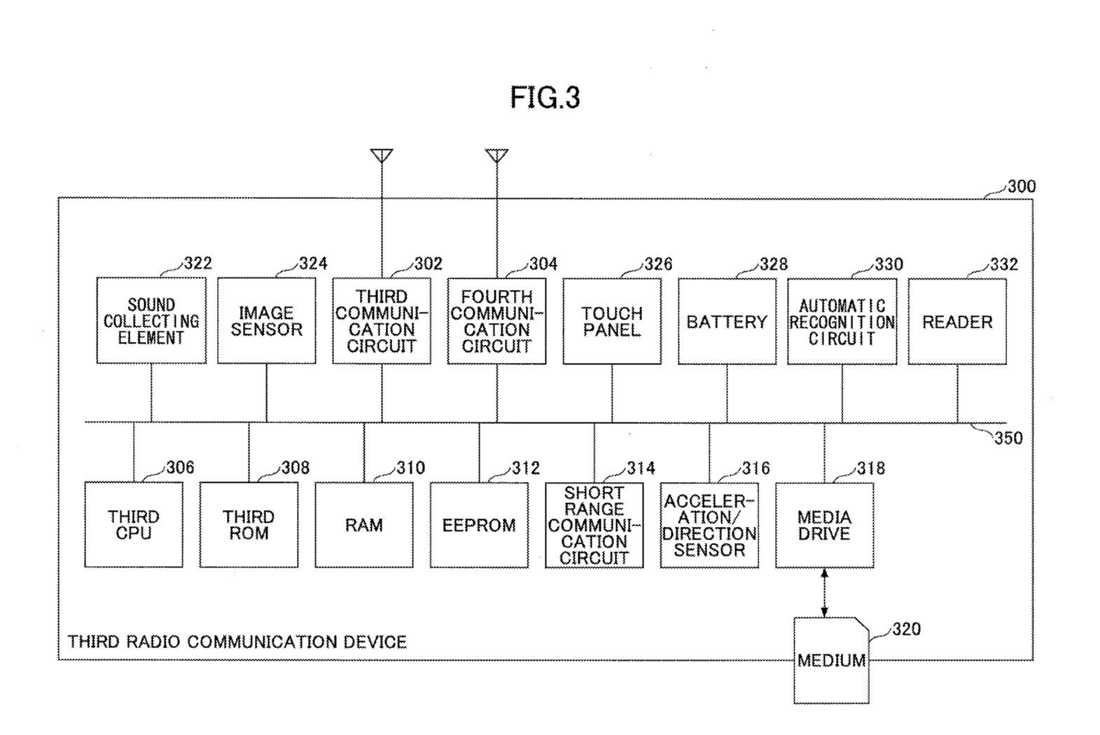

FIG. 3 shows a hardware configuration example of the third radio communication device 300 according to the embodiment. As shown in FIG. 3, the third radio communication device 300 according to the embodiment may include a first radio communication unit 302 for executing radio communication in accordance with the standard of the first radio communication scheme; a fourth communication circuit 304 for transmitting and receiving radio signals through an antenna in accordance with the standard of the second communication scheme; and a third CPU 306 for controlling operations of the whole third radio communication device 300. The third radio communication device 300 may include a third ROM 308 that stores a program that is used for driving the third CPU 306, such as an initial program loader (IPL); and a RAM 310 that can be used as a work area of the third CPU 306. The third radio communication device 300 may include an electrically erasable programmable read-only memory (EEPROM) 312 that stores various types of data, such as a program for the third radio communication device 300, image data, audio data, and so forth; a short range communication circuit 314 for executing short range communication based on a standard, such as Ultra Wide Band (UWB), visible light communication, infrared communication (Infrared Data Association (IrDA)), and so forth; and an acceleration/direction sensor 316. The third radio communication device 300 may include a media drive 318 for controlling reading out data from and writing (storing) data in a recording medium 320, such as a flash memory; a sound collecting element 322 for collecting sound waves in a specific direction; and a built-in image sensor 324 for capturing an image of an object in accordance with control of the third CPU 306 to obtain image data. As an image sensor, a complementary metal oxide semiconductor (CMOS), a charge coupled device (CCD), and so forth can be used. The third radio communication device 300 may include a touch panel 326 that displays various types of information, such as a cursor, a menu, a window, a character, and an image, and that receives an operation of a user; and a battery 328 that is a power source of the third radio communication device 300. The third radio communication device 300 may include an automatic recognition circuit 330 that automatically recognizes a graphic image, such as a Quick Response (QR) code and a bar code; a reader 332 for reading information from a tag, such as an RF tag and an IC tag; and a bus line 350 for electrically connecting the above-described components as shown in FIG. 3, such as an address bus and a data bus.

Here, the program for the third radio communication device 300 may be stored in a computer readable recording medium, such as a recording medium 320, as a file in an installable format or in an executable format, and the program for the third radio communication device 300 may be distributed. Furthermore, the program for the third radio communication device 300 may be stored in the third ROM 308, instead of the EEPROM 312.

### Operation of the Radio Communication System (Version 1)

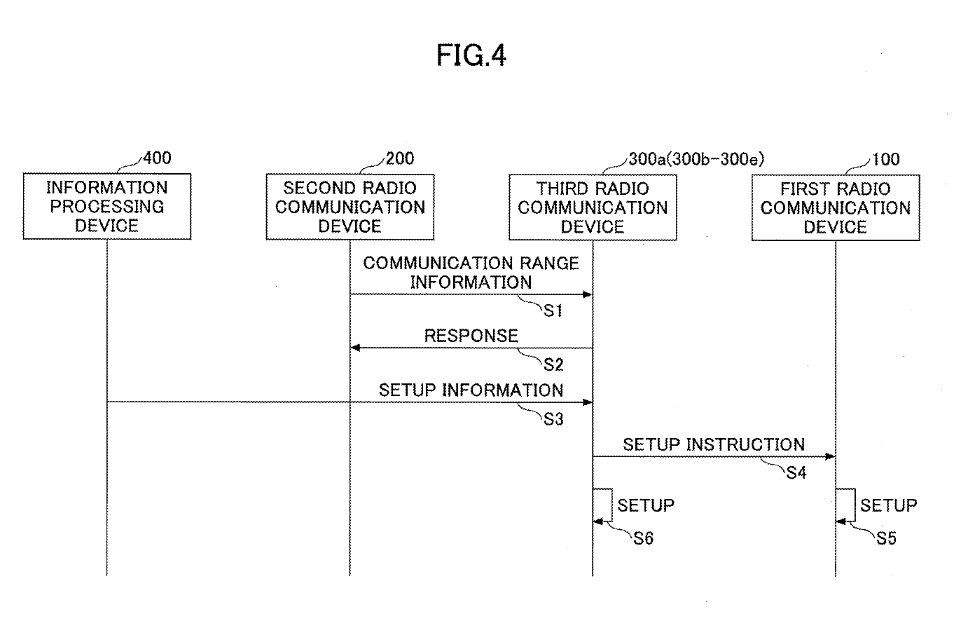

FIG. 4 shows a connection process in the radio communication system according to the embodiment. In the example that is shown in FIG. 4, communication can be established by the third radio communication device 300a by executing the connection process with the first radio communication device 100. The connection process may be applied for a case where one or more of the third radio communication devices 300b-300e execute a connection process with the first radio communication device 100.

At step S1, the second radio communication device 200 that forms the second radio communication area 250 transmits, to the third radio communication device 300a, communication range information that indicates the second radio communication area 250. For example, the second radio communication device 200 may notify peripheral devices of the presence of the own device by transmitting advertisement packets through three advertisement channels. The advertisement packet may include the communication range information that indicates the second radio communication area 250.

At step S2, the third radio communication device 300a receives the communication range information that is transmitted by the second radio communication device 200, and the third radio communication device 300a transmits, to the second radio communication device 200, a response signal with respect to the communication range information. The third radio communication device 300a can recognize that the third radio communication device 300a is located within the second radio communication area 250 by referring to the communication range information.

At step S3, in response to detecting that the third radio communication device 300a is located within the predetermined area where the third radio communication device 300a can receive the setup information from the information processing device 400, the third radio communication device 300a can obtain setup information from the information processing device 400. The third radio communication device 300a can obtain, from the information processing device 400, the setup information that can be used for establishing a connection with the first radio communication device 100 that forms the first radio communication area 150. For example, the third radio communication device 300a obtains, from the information processing device 400, the setup information, such as a PIN code (unique identification information) based on the WPS method that is standardized by the Wi-Fi Alliance and that facilitates wireless LAN connection.

At step S4, upon receiving the setup information from the information processing device 400, the third radio communication device 300a transmits, to the first radio communication device 100, a setup instruction signal for instructing setup by using the setup information.

At step S5, upon receiving the setup instruction signal that is transmitted by the third radio communication device 300a, the first radio communication device 100 sets up communication. At step S6, the third radio communication device 300a sets up communication. In this manner, in the overlap area where the first radio communication area 150 overlaps the second radio communication area 250, communication in accordance with the first radio communication scheme can be established between the third radio communication device 300a and the first radio communication device 100.

As described above, in the radio communication system according to the embodiment, the third radio communication device 300 can obtain the setup information from the information processing device 400. In response to detecting that the third radio communication device 300 is located in the overlap area where the first radio communication area 150 that is formed by the first radio communication device 100 overlaps the second radio communication area 250 that is formed by the second radio communication device 200, the third radio communication device 300 can set up communication with the first radio communication device 100 by using the setup information.

### Operation of the Radio Communication System (Version 2)

FIG. 5 shows a disconnection process in the radio communication system according to the embodiment. In the example that is shown in FIG. 5, upon the third radio communication device 300a exiting from the second radio communication area 250, the communication that is established between the third radio communication device 300a and the first radio communication device 100 is disconnected. In the example that is shown in FIG. 5, the disconnection process can be applied for disconnecting, upon the third radio communication devices 300b-300e exiting from the second radio communication area 250, the communication that is established between the third radio communication devices 300b-300e and the first radio communication device 100.

At step S11, the second radio communication device 200 that forms the second radio communication area 250 transmits, to the third radio communication device 300a, the communication range information that indicates the second radio communication area 250 at predetermined timing.

The third radio communication device 300a includes a positioning device, such as a Global Positioning System (GPS) device, and the third radio communication device 300a detects, at step S12, the current location of the third radio communication device 300a. Similarly, the second radio communication device 200 includes a positioning device, such as a GPS device, and the second radio communication device 200 detects the current location of the second radio communication device 200. By comparing the communication range information that is transmitted by the second radio communication device 200 with the current location of the third radio communication device 300a that is detected by the positioning device, the third radio communication device 300a determines whether the current location of the third radio communication device 300a is within the second radio communication area 250. Additionally, the third radio communication device 300a may measure Received Signal Strength Indication (RSSI) of the communication range information that is transmitted by the second radio communication device 200, and the third radio communication device 300a may convert the RSSI into a distance. Then, by comparing the communication range information that is transmitted by the second radio communication device 200 with the distance that is obtained by converting the RSSI, the third radio communication device 300a may determine whether the current location of the third radio communication device 300a is within the second radio communication area 250. The third radio communication device 300a transmits, to the second radio communication device 200, a response signal to which information is attached that indicates whether the current location of the third radio communication device 300a is within the second radio communication area 250.

Upon receiving, from the third radio communication device 300a, a response signal that indicates that the current location of the third radio communication device 300a is outside the second radio communication area 250 at step S13, the second radio communication device 200 transmits, to the third radio communication device 300a, a disconnection instruction signal for instructing to disconnect the communication with the second radio communication device 200. Note that a coverage area of the radio waves of the second radio communication device 200 is set to be wider than the second radio communication area 250. Consequently, even if the third radio communication device 300a is located outside the second radio communication area 250, the third radio communication device 300a can receive the disconnection instruction signal that is transmitted by the second radio communication device 200.

Upon receiving, at step S14, the disconnection instruction signal that is transmitted by the second radio communication device 200, the third radio communication device 300a transmits, to the first radio communication device 100, a disconnection instruction signal for instructing to disconnect the communication with the third radio communication device 300a. At step S15, the first radio communication device 100 executes a process for disconnecting the communication with the third radio communication device 300a. At step S16, the third radio communication device 300a executes a process for disconnecting the communication with the first radio communication device 100. In this manner, the communication between the third radio communication device 300a and the first radio communication device 100 is disconnected.

Here, for a case where the first radio communication device 100 and the second radio communication device 200 are configured to be a single radio communication device, the disconnection instruction signal for disconnecting the communication may be transmitted from the second radio communication device 200 to the first radio communication device 100.

The predetermined area that is formed by the information processing device 400 may not overlap the first radio communication area 150 that is covered by the first radio communication device 100 and the second radio communication area 250 that is covered by the second radio communication device 200. The predetermined area that is formed by the information processing device 400 may be formed outside the first radio communication area and the second radio communication area.

In this manner, in the radio communication system according to the embodiment, the communication among the third radio communication devices 300a through 300e can be restricted within the first radio communication area 150 that is formed by the first radio communication device 100 and within the second radio communication area 250. For the third radio communication device 300 that does not receive permission to establish communication with the first radio communication device 100 that forms the first radio communication area 150, the communication between the first radio communication device 100 and the third radio communication device 300 can be established while the third radio communication device 300 is located within the second radio communication area 250, and the communication between the first radio communication device 100 and the third radio communication device 300 can be used.

### Embodiment

As a radio communication system according to this embodiment, the radio communication system that is described by referring to FIG. 1 can be adopted. In the radio communication system, the information processing device 400 can form a predetermined area by using short range communication, such as UWB, and visible light communication. In response to detecting that the third radio communication device 300 enters the predetermined area, the information processing device 400 can execute a connection process with the third radio communication device 300, and the information processing device 400 can transmit setup information.

### Information Processing Device 400

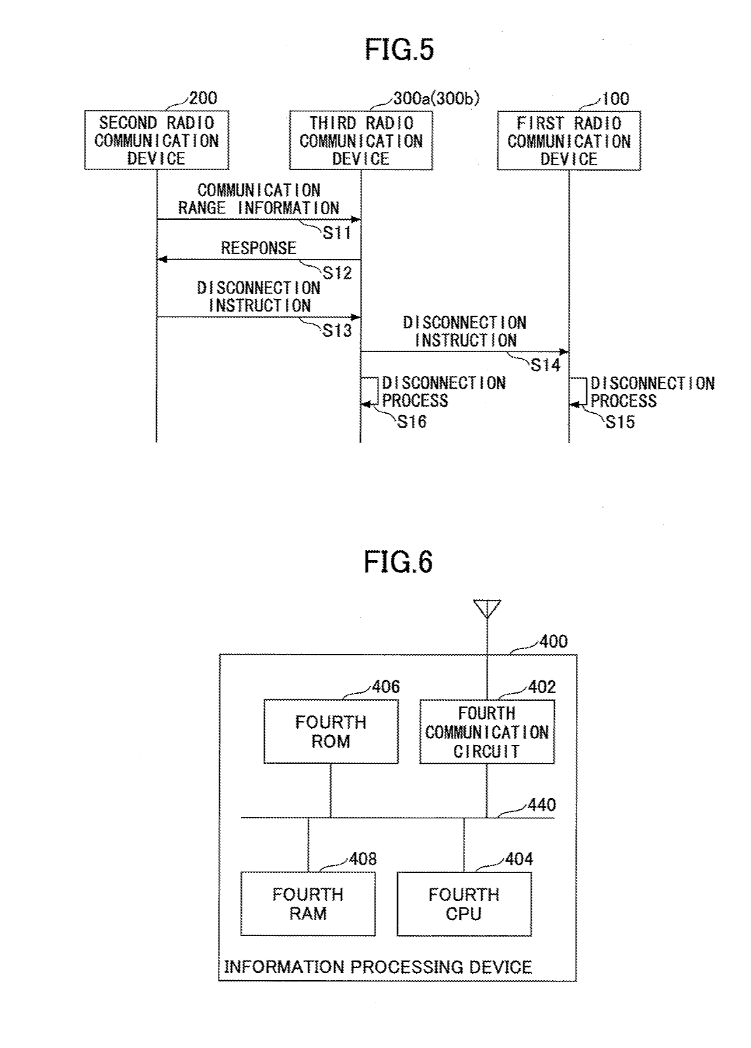

FIG. 6 shows a hardware configuration example of the information processing device 400 according to the embodiment. The information processing device 400 may include a fourth communication circuit 402 for transmitting and receiving radio signals through an antenna in accordance with a short range communication standard; and a fourth CPU 404 for controlling operations of the whole information processing device 400. Additionally, the information processing device 400 may include a fourth ROM 406 that stores various types of data, such as a program for the information processing device 400 that is used for driving the information processing device 400, transmit data, and so forth; and a fourth RAM 408 that can be used as a work area of the fourth CPU 404. The fourth communication circuit 402, the fourth CPU 404, the fourth ROM 406, and the fourth RAM 408 can be connected by a fourth bus 440. The program for the information processing device 400 may be stored in a computer readable recording medium, such as a storage medium, as a file in an installable format or in an executable format, and the program for the information processing device 400 may be distributed.

Here, the first radio communication device 100, the second radio communication device 200, and the information processing device 400 can be configured as a single radio communication device.

### Functional Configuration of the Embodiment

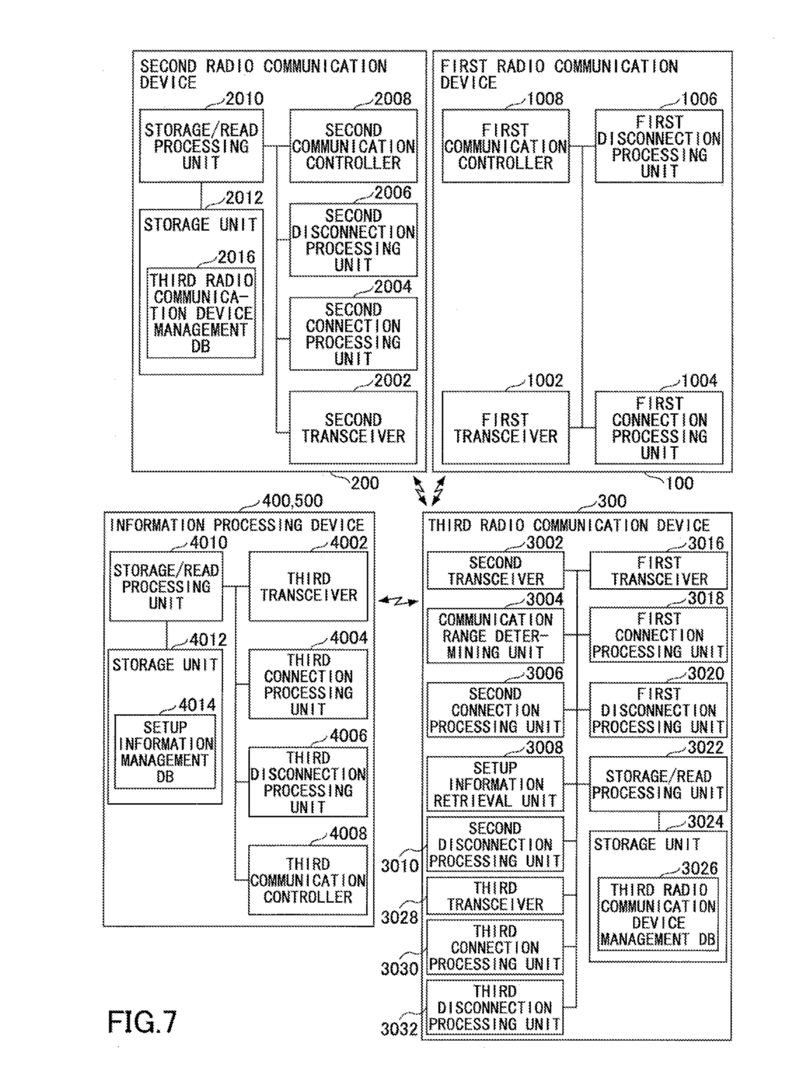

FIG. 7 is a functional block diagram of the first radio communication device 100, the second radio communication device 200, the third radio communication device 300, and the information processing device 400 according to the embodiment.

The first radio communication device 100 may include a first transceiver 1002; a first connection processing unit 1004; a first disconnection processing unit 1006; and a first communication controller 1008. These units can be functions or units that can be achieved by operating some components of the first radio communication device 100, which are shown in FIG. 2, by one or more instructions from the first CPU 104 in accordance with the program for the first radio communication device 100 that is stored in the first ROM 106.

### First Radio Communication Device 100

Next, each unit of the first radio communication device 100 is described in detail. The first transceiver 1002 of the first radio communication device 100 can be achieved by the first communication circuit 102, which is shown in FIG. 2, and one or more instructions from the first CPU 104; and the first transceiver 1002 can communicate various types of data (information) with the third radio communication device 300 by the first radio communication scheme.

The first connection processing unit 1004 of the first radio communication device 100 can be achieved by one or more instructions from the first CPU 104, which is shown in FIG. 2; and the first connection processing unit 1004 can establish communication by executing a connection process with the third radio communication device 300 based on the first radio communication scheme, by using the setup information that is transmitted from the third radio communication device 300.

The first disconnection processing unit 1006 of the first radio communication device 100 can be achieved by one or more instructions from the first CPU 104, which is shown in FIG. 2, and the first disconnection processing unit 1006 can disconnect communication with the third radio communication device 300 in accordance with a disconnection instruction that is transmitted by the third radio communication device 300.

The first communication controller 1008 of the first radio communication device 100 can be achieved by the first CPU 104, which is shown in FIG. 2, and one or more instructions from the first communication controller 110; and the first communication controller 1008 can execute communication control in accordance with the first radio communication scheme with the third radio communication device 300, for which the connection process is executed by the first connection processing unit 1004.

### Second Radio Communication Device 200

The second radio communication device 200 may include a second transceiver 2002; a second connection processing unit 2004; a second disconnection processing unit 2006; a second communication controller 2008; a storage/read processing unit 2010; and a storage unit 2012. These units can be functions or units that can be achieved by operating some components of the second radio communication device 200, which are shown in FIG. 2, by one or more instructions from the second CPU 204 in accordance with the program for the second radio communication device 200 that is stored in the second ROM 206.

(Third Radio Communication Device Management Table)

In the storage unit 2012, a third radio communication device management DB 2016 is provided, which includes a third radio communication device management table, such as shown in Table 1.

TABLE 1

| | | |
|---|---|---|
| Address of the third | Type of the third | IP address of |
| radio communication | radio communication | the third radio |
| device in the second | device | communication |
| radio communication | | device |
| scheme | | |
| Address of the third | Type of the third | IP address of |
| radio communication | radio communication | the third radio |
| device 300a in the | device 300a | communication |
| second radio | | device 300a |
| communication scheme | | |
| Address of the third | Type of the third | IP address of |
| radio communication | radio communication | the third radio |
| device 300b in the | device 300b | communication |
| second radio | | device 300b |
| communication scheme | | |
| . . . | . . . | . . . |

The third radio communication device management table defines correspondence among an address of the third radio communication device 300 in the second radio communication scheme; a type of the third radio communication device 300; and an IP address of the third radio communication device 300, by associating them. The address of the third radio communication device 300 in the second radio communication scheme is obtained upon detecting the third radio communication device 300 by the second radio communication scheme, and the address of the third radio communication device 300 in the second radio communication scheme can be used to determine a range of communication that is executed by the second radio communication scheme. An example of the address of the third radio communication device 300 in the second radio communication scheme can be a Bluetooth address, such as BD_ADDR, or a Bluetooth device address. The type of the third radio communication device 300 represents a type of the device, such as a smart device. The second radio communication device 200 selects a target to be controlled based on the information that is listed in the third radio communication device management table.

### Functional Units of the Second Radio Communication Device 200

Next, each element of the second radio communication device 200 is described in detail. The second transceiver 2002 of the second radio communication device 200 can be achieved by the second communication circuit 202, which is shown in FIG. 2, and one or more instructions from the second CPU 204; and the second transceiver 2002 can communicate various types of data (information) with the third radio communication device 300 by the second radio communication scheme.

The second connection processing unit 2004 of the second radio communication device 200 can be achieved by one or more instructions from the second CPU 204, which is shown in FIG. 2; and the second connection processing unit 2004 can create communication range information that is to be transmitted to the third radio communication device 300, and the communication range information can be transmitted by the second transceiver 2002. Additionally, upon receiving a response signal that is transmitted from the third radio communication device 300 that includes the communication range information, the second connection processing unit 2004 can establish communication by executing a connection process, such as a pairing process, with the third radio communication device 300.

The second disconnection processing unit 2006 of the second radio communication device 200 can be achieved by one or more instructions from the second CPU 204, which is shown in FIG. 2. In response to detecting that information indicating that the current location of the third radio communication device 300 is outside the second radio communication area 250 is attached to the response signal that is transmitted by the third radio communication device 300 that is executing communication with the first radio communication device 100, the second disconnection processing unit 2006 can create disconnection instruction information, and the disconnection instruction information can be transmitted to the third radio communication device 300 from the second transceiver 2002.

The second communication controller 2008 of the second radio communication device 200 can be achieved by one or more instructions from the second communication controller 210, which is shown in FIG. 2; and the second communication controller 2008 can execute communication control between the third radio communication device 300, with which the connection process is executed by the second connection processing unit 2004, and the second radio communication device 200.

The storage/read processing unit 2010 of the second radio communication device 200 can be achieved by one or more instructions from the second CPU 204, which is shown in FIG. 2, and the second ROM 206, which is shown in FIG. 2 as an example. The storage/read processing unit 2010 can store various types of data in the storage unit 2012, and the storage/read processing unit 2010 can execute a process of reading out the various types of data stored in the storage unit 2012.

### Third Radio Communication Device 300

The third radio communication device 300 may include a second transceiver 3002; a communication range determining unit 3004; a second connection processing unit 3006; a setup information retrieval unit 3008; a second disconnection processing unit 3010; a first transceiver 3016; a first connection processing unit 3018; a first disconnection processing unit 3020; a storage/read processing unit 3022; a storage unit 3024; a third transceiver 3028; a third connection processing unit 3030; and a third disconnection processing unit 3032. These units can be functions or units that can be achieved by operating some components of the third radio communication device 300, which are shown in FIG. 3, by one or more instructions from the third CPU 306 in accordance with the program for the third radio communication program 300, which is stored in the EEPROM 312.

(Third Radio Communication Device Management Table)

In the storage unit 3024, a third radio communication device management DB 3026 is provided, which includes a third radio communication device management table. For the third radio communication device management table, the above-described Table 1 may be adopted.

### Functional Units of the Third Radio Communication Device 300

Next, each element of the third radio communication device 300 is described in detail.

The second transceiver 3002 of the third radio communication device 300 can be achieved by the fourth communication circuit 304, which is shown in FIG. 3, and one or more instructions from the third CPU 306; and the second transceiver 3002 can communicate various types of data (information) with the second radio communication device 200 by the second radio communication scheme.

The communication range determining unit 3004 of the third radio communication device 300 can be achieved by one or more instructions from the third CPU 306, which is shown in FIG. 3. The communication range determining unit 3004 can determine whether the current location of the third radio communication device 300 is within the second radio communication area 250 by comparing the communication range information that is transmitted by the second radio communication device 200 with a distance that is obtained by converting the Received Signal Strength Indication of the communication range information. The communication range determining unit 3004 can create a response signal to which information indicating whether the current location of the third radio communication device 300 is within the second radio communication area 250, and the response signal can be transmitted from the second transceiver 3002 to the second radio communication device 200.

The second connection processing unit 3006 of the third radio communication device 300 can be achieved by one or more instructions from the third CPU 306, which is shown in FIG. 3; and the second connection processing unit 3006 can execute a connection process with the second radio communication device 200 by the second radio communication scheme.

The second disconnection processing unit 3010 of the third radio communication device 300 can be achieved by one or more instructions from the third CPU 306, which is shown in FIG. 3. The second disconnection processing unit 3010 can disconnect communication with the second radio communication device 200 in the second radio communication scheme.

The first transceiver 3016 of the third radio communication device 300 can be achieved by the third communication circuit 302, which is shown in FIG. 3, and one or more instructions from the third CPU 306; and the first transceiver 3016 can communicate various types of data (information) with the first radio communication device 100 by the first radio communication scheme.

The first connection processing unit 3018 of the third radio communication device 300 can be achieved by one or more instructions from the third CPU 306, which is shown in FIG. 3; and the first connection processing unit 3018 can execute a connection process with the first radio communication device 100 by the first communication scheme.

The first disconnection processing unit 3020 of the third radio communication device 300 can be achieved by one or more instructions from the third CPU 306, which is shown in FIG. 3. The first disconnection processing unit 3020 can disconnect communication with the first radio communication device 100 by the first communication scheme.

The storage/read processing unit 3022 of the third radio communication device 300 can be achieved by one or more instructions from the third CPU 306, and the EEPROM 312, which are shown in FIG. 3 as an example. The storage/read processing unit 3022 can store various types of data in the storage unit 3024; and the storage/read processing unit 3022 can execute a process of reading out the various types of data stored in the storage unit 3024.

The third transceiver 3028 of the third radio communication device 300 can be achieved by the short range communication circuit 314, which is shown in FIG. 3, and one or more instructions from the third CPU 306. The third transceiver 3028 can communicate various types of data (information) with the information processing device 400 by a short range communication method that is based on a standard, such as UWB, visible light communication, infrared communication, and so forth.

The third connection processing unit 3030 of the third radio communication device 300 can be achieved by one or more instructions from the third CPU 306, which is shown in FIG. 3. The third connection processing unit 3030 can execute a connection process with the information processing device 400 by the short range communication method.

The setup information retrieval unit 3008 of the third radio communication device 300 can be achieved by the short range communication circuit 314, which is shown in FIG. 3, and one or more instructions from the fourth CPU 306. The setup information retrieval unit 3008 can obtain, from the third transceiver 3028, the setup information that is transmitted by the information processing device 400, with which the connection process is executed by the third connection processing unit 3030.

The third disconnection processing unit 3032 of the third radio communication device 300 can be achieved by one or more instructions from the third CPU 306, which is shown in FIG. 3. The third disconnection processing unit 3032 can disconnect communication with the information processing device 400 by the short range communication method.

### Information Processing Device 400

The information processing device 400 may include a third transceiver 4002; a third connection processing unit 4004; a third disconnection processing unit 4006; a third communication controller 4008; a storage/read processing unit 4010; and a storage unit 4012. These units can be functions or units that can be achieved by operating some components of the information processing device 400, which are shown in FIG. 6, by one or more instructions from the fourth CPU 404 in accordance with the program for the information processing device 400 that is stored in the fourth ROM 406.

(Setup Information Management Table)

In the storage unit 4012, a setup information management DB 4014 is provided, which includes a setup information management table, such as shown in Table 2.

TABLE 2

| | Security | | | Port |
|---|---|---|---|---|
| SSID | method | Password | IP address | number |
| zzzzzz | WPA2 | wwwwww | 192.168.10.10 | αα |

The setup information management table defines correspondence among connection information items by associating the connection information items, e.g., the network information, such as a Service Set Identifier (SSID), a security method, and a password; and the address information, such as IP address, and a port number, which are used by the third radio communication device 300 for attempting to establish connection with the first radio communication device 100 by the first communication scheme. The SSID is identification information of the wireless LAN; and the security method is represented by a standard of an encryption method, such as WEP, WPA, WPA2, WPA2-TKIP, and AES.

### Functional Units of the Information Processing Device 400

Next, each element of the information processing device 400 is described in detail.

The third transceiver 4002 of the information processing device 400 can be achieved by the fourth communication circuit 404, which is shown in FIG. 6, and one or more instructions from the fourth CPU 404; and the third transceiver 4002 can communicate various types of data (information) with the third radio communication device 300 by the short range communication method.

The third connection processing unit 4004 of the information processing device 400 can be achieved by one or more instructions from the fourth CPU 404, which is shown in FIG. 6; and the third connection processing unit 4004 can execute a connection process with the third radio communication device 300 by the short range communication method.

The third disconnection processing unit 4006 of the information processing device 400 can be achieved by one or more instructions from the fourth CPU 404, which is shown in FIG. 6. The third disconnection processing unit 4006 can disconnect communication with the third radio communication device 300 in the short range communication method.

The third communication controller 4008 of the information processing device 400 can be achieved by one or more instructions from the fourth CPU 404, which is shown in FIG. 6. The third communication controller 4008 can execute communication control with the third radio communication device 300, with which the connection process is executed by the third connection processing unit 4004, in accordance with the short range communication method.

The storage/read processing unit 4010 of the information processing device 400 can be achieved by one or more instructions from the fourth CPU 404, which is shown in FIG. 6, and the fourth ROM 406, which is shown in FIG. 6 as an example. The storage/read processing unit 4010 can store various types of data in the storage unit 4012, and the storage/read processing unit 2010 can execute a process of reading out the various types of data stored from the storage unit 4012.

### Operation of the Radio Communication System

As the operation of the radio communication system, the operation processes that are shown in FIGS. 4 and 5 can be applied. However, at step S3, the third connection processing unit 3030 of the third radio communication device 300a executes a connection process with the third connection processing unit 4004 of the information processing device 400 by the short range communication method. The setup information retrieval unit 3008 of the third radio communication device 300a requests the setup information from the information processing device 400. The third communication controller 4008 of the information processing device 400 obtains the setup information by causing the storage/read processing unit 4010 to read out the setup information of the setup information management DB 4014 from the storage unit 4012 in accordance with the setup information request that is transmitted by the third radio communication device 300a. The third communication controller 4008 transmits the setup information to the third radio communication device 300a. The third transceiver 3028 of the third radio communication device 300a receives the setup information that is transmitted by the information processing device 400.

According to the embodiment, the third radio communication device 300 can obtain, within the predetermined area that is smaller than the second radio communication area covered by the second radio communication device 200, the setup information that is used for establishing a connection with the first radio communication device 100. In this manner, the setup information can be prevented from being obtained by a user who is at a location that may not be visually confirmed, such as a location outside a wall, and thereby security can be enhanced.

### Another Embodiment

As the radio communication system according to this embodiment, the radio communication system that is described by referring to FIG. 1 can be applied. However, an information processing device 500 is used, instead of the information processing device 400. In the radio communication system, the information processing device 500 forms a predetermined area by short range communication, such as infrared communication. Upon detecting that the third radio communication device 300 enters the predetermined area, the information processing device 500 executes a connection process with the third radio communication device 300, and the information processing device 500 transmits the setup information.

### Information Processing Device 500

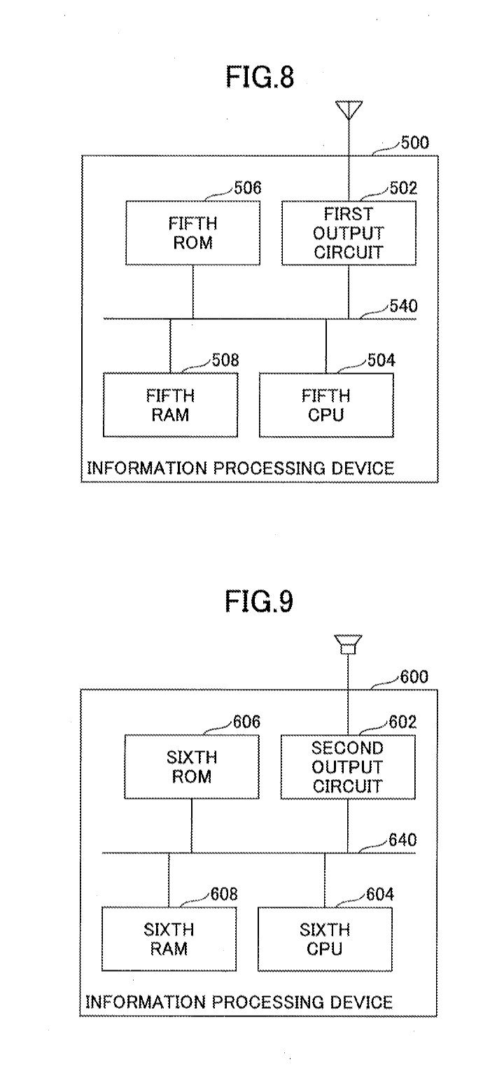

FIG. 8 shows a hardware configuration example of the information processing device 500 according to the embodiment. The information processing device 500 may include a first output circuit 502 that outputs infrared optical signals in accordance with a short range communication standard; and a fifth CPU 504 that controls overall operation of the information processing device 500. Additionally, the information processing device 500 may include a fifth ROM 506 that stores various types of data, such as a program for the information processing device 500 that can be used for driving the information processing device 500, and transmit data; and a fifth RAM 508 that can be used as a work area of the fifth CPU 504. The first output circuit 502, the fifth CPU 504, the fifth ROM 506, and the fifth RAM 508 can be connected by a fifth bus 540. The program for the information processing device 500 may be stored in a computer readable recording medium, such as a storage medium, as a file in an installable format or in an executable format, and the program for the information processing device 500 may be distributed. Here, the first radio communication device 100, the second radio communication device 200, and the information processing device 500 may be configured as a single radio communication device.

### Functional Configuration of the Embodiment

As a functional block diagram of the first radio communication device 100, the second radio communication device 200, the third radio communication device 300, and the information processing device 500, the functional block diagram of FIG. 7 can be applied. Here, the third transceiver 3028 of the third radio communication device 300 can be achieved by the short range communication circuit 314, which is shown in FIG. 3, and one or more instructions from the third CPU 306. The third transceiver 3028 can communicate various types of data (information) with the information processing device 500 in accordance with a short range communication method, such as infrared communication. Further, the third connection processing unit 3030 of the third radio communication device 300 can be achieved by one or more instructions from the third CPU 306, which is shown in FIG. 3. The third connection processing unit 3030 can execute a connection process with the information processing device 500 by the short range communication method. The setup information retrieval unit 3008 of the third radio communication device 300 can be achieved by the short range communication circuit 314, which is shown in FIG. 3, and one or more instructions from the third CPU 306; and the setup information retrieval unit 3008 can obtain, from the third transceiver 3028, the setup information that is transmitted by the information processing circuit 500, with which the connection process is executed by the third connection processing unit 3030. The disconnection processing unit 3032 of the third radio communication device 300 can be achieved by one or more instructions from the third CPU 306, which is shown in FIG. 3. The third disconnection processing unit 3032 can disconnect communication with the information processing device 500 that is in accordance with the short range communication.

### Information Processing Device 500

For the information processing device 500, the configuration of the information processing device 500 that is shown in FIG. 7 can be applied.

### Operation of the Radio Communication System

As the operation of the radio communication system, the operation processes that are shown in FIGS. 4 and 5 can be applied. However, at step S3, the third connection processing unit 3030 of the third radio communication device 300a executes a connection process with the third connection processing unit 4004 of the information processing device 500 by the short range communication method. The setup information retrieval unit 3008 of the third radio communication device 300a requests the setup information from the information processing device 500. The third communication controller 4008 of the information processing device 500 obtains the setup information by causing the storage/read processing unit 4010 to read out the setup information of the setup information management DB 4014 from the storage unit 4012 in accordance with the setup information request that is transmitted by the third radio communication device 300a. The third communication controller 4008 transmits the setup information to the third radio communication device 300a. The third transceiver 3028 of the third radio communication device 300a receives the setup information that is transmitted by the information processing device 500.

According to the embodiment, the third radio communication device 300 can obtain the setup information that is used for establishing a connection with the first radio communication device 100 within the predetermined area, which is smaller than the second radio communication area 250 that is covered by the second radio communication device 200. In this manner, the setup information can be prevented from being obtained by a user who is at a location that may not be visually confirmed, such as a location outside a wall, and thereby security can be enhanced.

### Another Embodiment

As the radio communication system according to this embodiment, the radio communication system that is described by referring to FIG. 1 can be applied. However, an information processing device 600 is used, instead of the information processing device 400. In the radio communication system, the information processing device 600 transmits the setup information by sound waves, such as supersonic waves, and infrasound. As a consequence, a predetermined area is formed in which the setup information can be obtained. Upon entering the predetermined area that is formed by the information processing device 600, the third radio communication device 300 collects sound waves that are transmitted from the information processing device 600, and the third radio communication device 300 obtains the setup information.

### Information Processing Device 600

FIG. 9 shows a hardware configuration example of the information processing device 600 according to the embodiment. The information processing device 600 may include a second output circuit 602 that outputs sound waves; and a sixth CPU 604 that controls overall operation of the information processing device 600. Additionally, the information processing device 600 may include a sixth ROM 606 that stores various types of data, such as a program for the information processing device 600 that can be used for driving the information processing device 600, and transmit data; and a sixth RAM 608 that can be used as a work area of the sixth CPU 604. The second output circuit 602, the sixth CPU 604, the sixth ROM 606, and the sixth RAM 608 can be connected by a sixth bus 640. The program for the information processing device 600 may be stored in a computer readable recording medium, such as a storage medium, as a file in an installable format or in an executable format, and the program for the information processing device 600 may be distributed. Here, the first radio communication device 100, the second radio communication device 200, and the information processing device 600 may be configured as a single radio communication device.

### Functional Configuration of the Embodiment

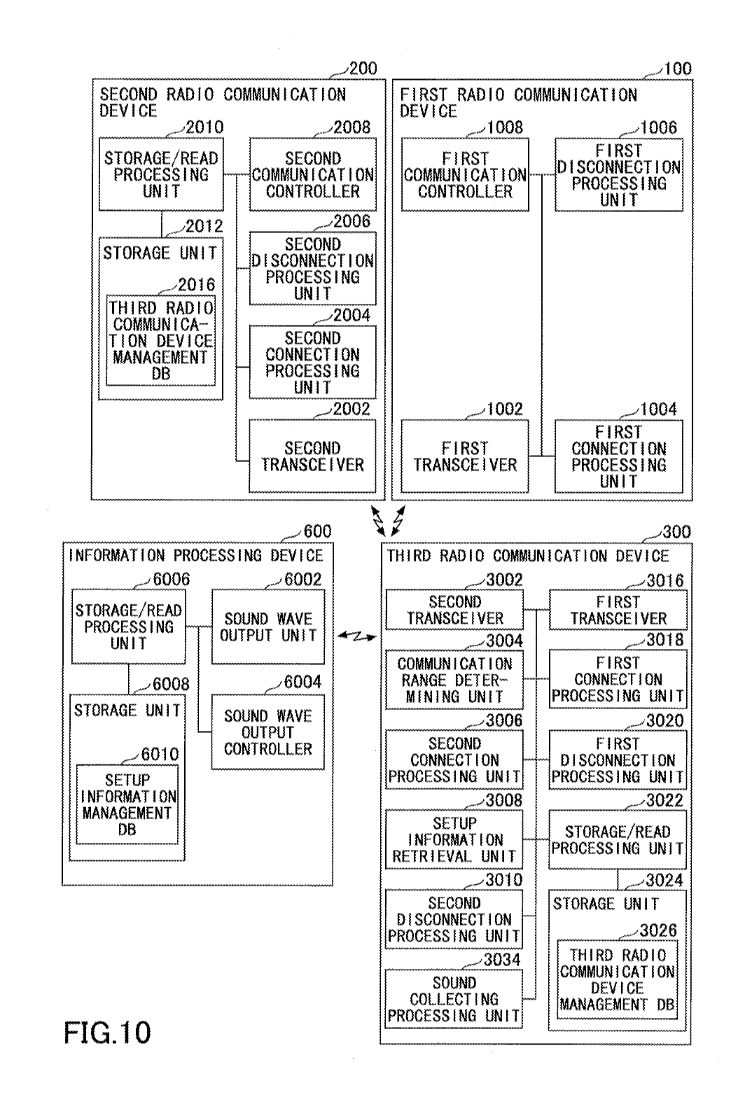

FIG. 10 is a functional block diagram of the first radio communication device 100, the second radio communication device 200, the third radio communication device 300, and the information processing device 600 according to the embodiment. As functional configurations of the first radio communication device 100 and the second radio communication device 200, the functional configurations that are shown in FIG. 7 can be applied. The third radio communication device 300 includes a sound collecting processing unit 3034, instead of the third transceiver 3028, the third connection processing unit 3030, and the third disconnection processing unit 3032 of the third radio communication device 300 that is shown in FIG. 7.

The sound collecting processing unit 3034 of the third radio communication device 300 can be achieved by the sound collecting element 322 and one or more instructions from the third CPU 306. The sound collecting processing unit 3034 collects sound waves that are transmitted by the information processing device 600, and the sound collecting processing unit 3034 inputs the collected sound waves to the setup information retrieval unit 3008.

The setup information retrieval unit 3008 of the third radio communication device 300 can be achieved by the sound collecting element 322, which is shown in FIG. 3, and one or more instructions from the third CPU 306; and the setup information retrieval unit 3008 retrieves the setup information by converting the sound waves that are collected by the sound collecting processing unit 3034 into data.

### Information Processing Device 600

The information processing device 600 may include a sound wave output unit 6002; a sound wave controller 6004; a storage/read processing unit 6006; and a storage unit 6008. As for the storage/read processing unit 6006 and the storage unit 6008, the storage/read processing unit 4010 and the storage unit 4012 that are shown in FIG. 7 can be applied. The sound wave output unit 6002 of the information processing device 600 can be achieved by the second output circuit 602, which is shown in FIG. 9, and one or more instructions from the sixth CPU 604; and the sound wave output unit 6002 outputs the setup information by using sound waves.

The sound wave controller 6004 of the information processing device 600 can be achieved by one or more instructions from the sixth CPU 604, which is shown in FIG. 9. The sound wave controller 6004 executes output control of sound waves that are to be output from the sound wave output unit 6002.

The storage/read processing unit 6006 of the information processing device 600 can be achieved by one or more instructions from the sixth CPU 604, which is shown in FIG. 9, and the sixth ROM 606, which is shown in FIG. 9 as an example. The storage/read processing unit 6006 can store various types of data in the storage unit 6008, and the storage/read processing unit 6006 can execute a process of reading out the various types of data stored from the storage unit 6008. In the storage unit 6008, a setup information management DB 6010 is provided, which includes a setup information management table, such as shown in Table 2.

### Operation of the Radio Communication System

As the operation of the radio communication system, the operation processes that are shown in FIGS. 4 and 5 can be applied. However, at step S3, the sound wave output unit 6002 of the information processing device 600 transmits the setup information by using sound waves, in accordance with the control of the sound wave controller 6004. The sound collecting processing unit 3034 of the third radio communication device 300 collects sound waves that are output from the sound wave output unit 6002 of the information processing device 600. The setup information retrieval unit 3008 obtains the setup information by converting the sound waves that are collected by the sound collecting processing unit 3034 into data.

According to the embodiment, the third radio communication device 300 can obtain, based on the sound waves that are transmitted by the information processing device 600, the setup information that is used for establishing a connection with the first radio communication device 100 within the predetermined area, which is smaller than the second radio communication area 250 that is covered by the second radio communication device 200. In this manner, the setup information can be prevented from being obtained by a user who is at a location that may not be visually confirmed, such as a location outside a wall, and thereby security can be enhanced.

### Another Embodiment

As the radio communication system according to this embodiment, the radio communication system that is described by referring to FIG. 1 can be applied. However, an information processing device 700 is used, instead of the information processing device 400. In the radio communication system, the information processing device 700 causes the third radio communication device 300 to obtain the setup information by using a graphic image, such as QR code (registered trademark), and a bar code. As a consequence, a predetermined area is formed in which the setup information can be obtained. Upon entering the predetermined area, the third radio communication device 300 captures a graphic image that is displayed by the information processing device 700, and thereby the third radio communication device 300 obtains the setup information.

### Information Processing Device 700

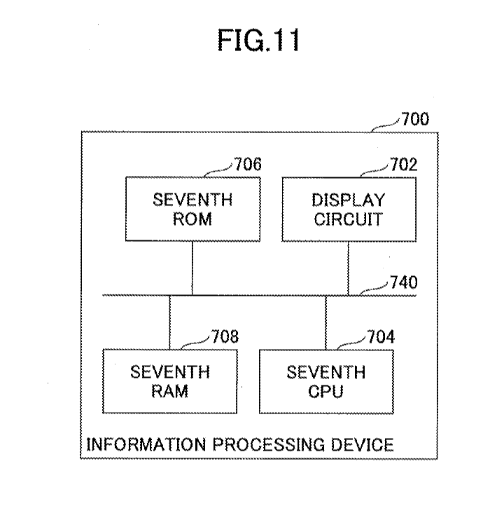

FIG. 11 shows a hardware configuration example of the information processing device 700 according to the embodiment. The information processing device 700 may include a display circuit 702 that displays a graphic image; and a seventh CPU 704 that controls overall operation of the information processing device 700. Additionally, the information processing device 700 may include a seventh ROM 706 that stores various types of data, such as a program for the information processing device 700 that can be used for driving the information processing device 700, and transmit data; and a seventh RAM 708 that can be used as a work area of the seventh CPU 704. The display circuit 702, the seventh CPU 704, the seventh ROM 706, and the seventh RAM 708 can be connected by a seventh bus 740. The program for the information processing device 700 may be stored in a computer readable recording medium, such as a storage medium, as a file in an installable format or in an executable format, and the program for the information processing device 700 may be distributed. Here, the first radio communication device 100, the second radio communication device 200, and the information processing device 700 may be configured as a single radio communication device.

### Functional Configuration of the Embodiment

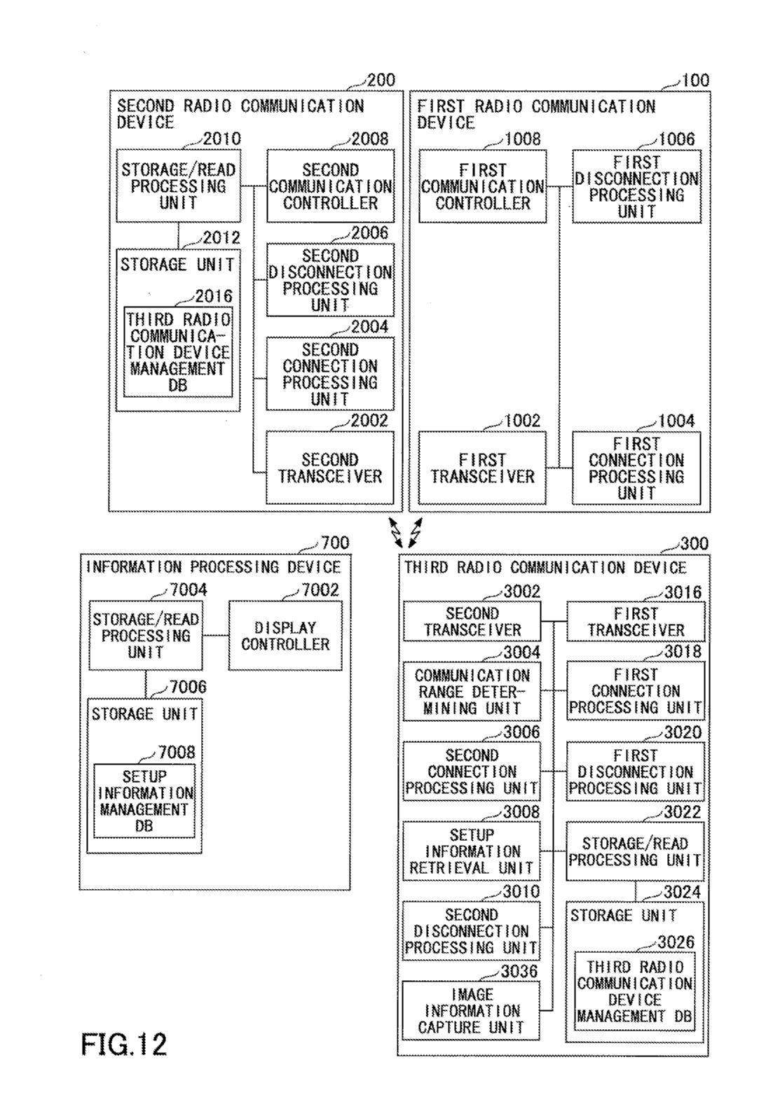

FIG. 12 is a functional block diagram of the first radio communication device 100, the second radio communication device 200, the third radio communication device 300, and the information processing device 700 according to the embodiment. As functional configurations of the first radio communication device 100 and the second radio communication device 200, the functional configurations that are shown in FIG. 7 can be applied. The third radio communication device 300 includes an image information capture unit 3036, instead of the third transceiver 3028, the third connection processing unit 3030, and the third disconnection processing unit 3032 of the third radio communication device 300 that is shown in FIG. 7.

The image information capture unit 3036 of the third radio communication device 300 can be achieved by the automatic recognition circuit 330, which is shown in FIG. 3, and one or more instructions from the third CPU 306. The image information capture unit 3036 captures a graphic image that is displayed by the information processing device 700, and the image information capture unit 3036 inputs the graphic image to the setup information retrieval unit 3008.

The setup information retrieval unit 3008 of the third radio communication device 300 can be achieved by the automatic recognition circuit 330, which is shown in FIG. 3, and one or more instructions from the third CPU 306; and the setup information retrieval unit 3008 obtains the setup information based on the graphic image that is captured by the image information capture unit 3036.

### Information Processing Device 700

The information processing device 700 may include a display controller 7002; a storage/read processing unit 7004; and a storage unit 7006. As for the configurations of the storage/read processing unit 7004 and the storage unit 7006, the configurations that are shown in FIG. 7 can be applied. The display controller 7002 of the information processing device 700 can be achieved by the display circuit 702, which is shown in FIG. 11, and one or more instructions from the seventh CPU 704; and the display controller 7002 outputs the setup information by using a graphic image.

The storage/read processing unit 7004 of the information processing device 700 can be achieved by one or more instructions from the seventh CPU 704, which is shown in FIG. 11, and the seventh ROM 706, which is shown in FIG. 11. The storage/read processing unit 7004 can store various types of data in the storage unit 7006, and the storage/read processing unit 7004 can execute a process of reading out the various types of data stored from the storage unit 7006. In the storage unit 7006, a setup information management DB 7008 is provided, which includes a setup information management table, such as shown in Table 2.

### Operation of the Radio Communication System

As the operation of the radio communication system, the operation processes that are shown in FIGS. 4 and 5 can be applied. However, at step S3, the display controller 7002 of the information processing device 700 displays the setup information by using a graphic image. The image information capture unit 3036 of the third radio communication device 300 captures a graphic image that is displayed by the display controller 7002 of the information processing device 700; and the setup information retrieval unit 3008 obtains the setup information based on the graphic image that is captured by the image information capture unit 3036.

According to the embodiment, the third radio communication device 300 can obtain, based on the graphic image that is displayed by the information processing device 700, the setup information that is used for establishing a connection with the first radio communication device 100 within the predetermined area, which is smaller than the second radio communication area 250 that is covered by the second radio communication device 200. In this manner, the setup information can be prevented from being obtained by a user who is at a location that may not be visually confirmed, such as a location outside a wall, and thereby security can be enhanced.

### Further Embodiment

As the radio communication system according to this embodiment, the radio communication system that is described by referring to FIG. 1 can be applied. However, an information processing device 800 is used, instead of the information processing device 400. In the radio communication system, the third radio communication device 300 obtains the setup information from the information processing device 800 by using proximity communication, such as proximity communication by using a radio frequency identifier (RFID). For example, upon placing the third radio communication device 300, by a user of the third radio communication device 300, in the area where the proximity communication with the information processing device 800 can be executed, the proximity communication between the third radio communication device 300 and the information processing device 800 is executed. As a consequence, the third radio communication device 300 obtains the setup information that is transmitted by the information processing device 800.

### Information Processing Device 800

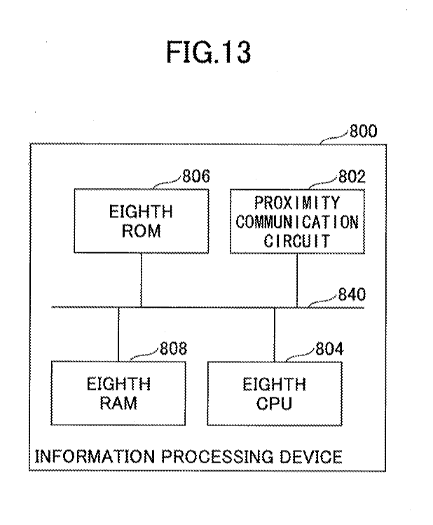

FIG. 13 shows a hardware configuration example of the information processing device 800 according to the embodiment. The information processing device 800 may include a proximity communication circuit 802 that transmits and receives radio signals in accordance with a proximity communication standard; and an eighth CPU 804 that controls overall operation of the information processing device 800. Additionally, the information processing device 800 may include an eighth ROM 806 that stores various types of data, such as a program for the information processing device 800 that can be used for driving the information processing device 800, and transmit data; and an eighth RAM 808 that can be used as a work area of the eighth CPU 804. The proximity communication circuit 802, the eighth CPU 804, the eighth ROM 806, and the eighth RAM 808 can be connected by an eighth bus 840. The program for the information processing device 800 may be stored in a computer readable recording medium, such as a storage medium, as a file in an installable format or in an executable format, and the program for the information processing device 500 may be distributed. Here, the first radio communication device 100, the second radio communication device 200, and the information processing device 800 may be configured as a single radio communication device.

### Functional Configuration of the Embodiment

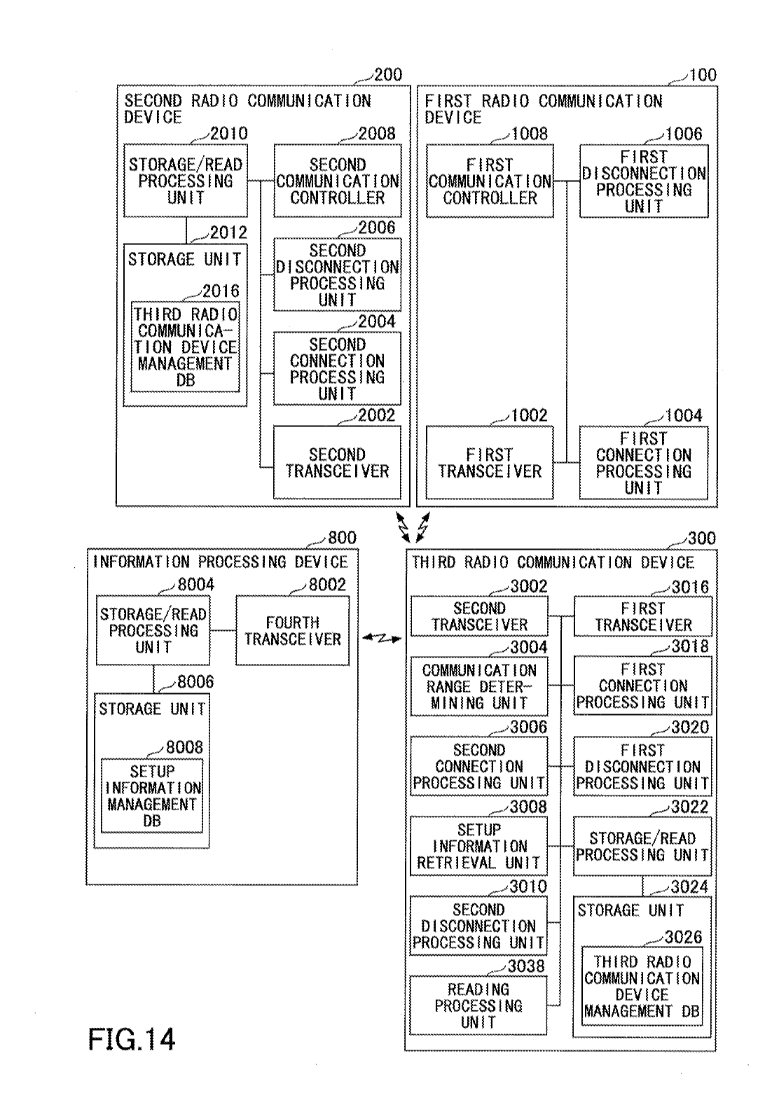

FIG. 14 is a functional block diagram of the first radio communication device 100, the second radio communication device 200, the third radio communication device 300, and the information processing device 800 according to the embodiment. As functional configurations of the first radio communication device 100 and the second radio communication device 200, the functional configurations that are shown in FIG. 7 can be applied. However, the third radio communication device 300 includes a reading processing unit 3038, instead of the third transceiver 3028, the third connection processing unit 3030, and the third disconnection processing unit 3032 of the third radio communication device 300 that is shown in FIG. 7.

The reading processing unit 3038 of the third radio communication device 300 can be achieved by the reader 332, which is shown in FIG. 3, and one or more instructions from the third CPU 306. The reading processing unit 3038 reads various types of data (information) that are transmitted from the information processing device 800 by proximity communication, and the reading processing unit 3038 inputs the various types of data to the setup information retrieval unit 3008.

The setup information retrieval unit 3008 of the third radio communication device 300 can be achieved by the reader 332, which is shown in FIG. 3, and one ore more instructions from the third CPU 306; and the setup information retrieval unit 3008 obtains the setup information based on data that is read by the reading processing unit 3038.

### Information Processing Device 800

The information processing device 800 may include a fourth transceiver 8002; a storage/read processing unit 8004; and a storage unit 8006. As for a storage/read processing unit 8004 and a storage unit 8006, the configurations that are shown in FIG. 7 can be applied. The fourth transceiver 8002 of the information processing device 800 can be achieved by the proximity communication circuit 802, which is shown in FIG. 13, and one or more instructions from the eighth CPU 804; and, upon detecting that the fourth transceiver 8002 is adjacent to the reader 332 of the third radio communication device 300, the fourth transceiver 8002 outputs the setup information.

The storage/read processing unit 8004 of the information processing device 800 can be achieved by one or more instructions from the eighth CPU 804, which is shown in FIG. 13, and the eighth ROM 806, which is shown in FIG. 13 as an example. The storage/read processing unit 8004 can store various types of data in the storage unit 8006, and the storage/read processing unit 8004 can execute a process of reading out the various types of data stored from the storage unit 8006. In the storage unit 8006, a setup information management DB 8008 is provided, which includes a setup information management table, such as shown in Table 2.

### Operation of the Radio Communication System

As the operation of the radio communication system, the operation processes that are shown in FIGS. 4 and 5 can be applied. However, at step S3, the fourth transceiver 8002 of the information processing device 800 transmits the setup information by the proximity communication. The reading processing unit 3038 of the third radio communication device 300 reads the setup information that is transmitted by the fourth transceiver 8002 of the information processing device 800; and the setup information retrieval unit 3008 obtains the setup information that is read by the reading processing unit 3038.

According to the embodiment, the third radio communication device 300 can obtain, from the information processing device 800, the setup information that is used for establishing a connection with the first radio communication device 100 within the predetermined area, which is smaller than the second radio communication area 250 that is covered by the second radio communication device 200. In this manner, the setup information can be prevented from being obtained by a user who is at a location that may not be visually confirmed, such as a location outside a wall, and thereby security can be enhanced.

The communication device and the communication method are described above by the embodiments. However, the present invention is not limited to the above-described embodiments, and various modifications and improvements can be made within the scope of the present invention. Specific examples of numerical values are used in order to facilitate understanding of the invention. However, these numerical values are simply illustrative, and any other appropriate values may be used, except as indicated otherwise. The separations of the items in the above explanation are not essential to the present invention. Depending on necessity, subject matter described in two or more items may be combined and used, and subject matter described in an item may be applied to subject matter described in another item (provided that they do not contradict). A boundary of a functional unit or a processor in the functional block diagrams may not necessarily correspond to a boundary of a physical component. An operation by a plurality of functional units may be physically executed by a single component, or an operation of a single functional unit may be physically executed by a plurality of components. For the convenience of explanation, the communication terminal and the information processing device are explained by using the functional block diagrams. However, these devices may be implemented in hardware, software, or combinations thereof. The software that operates in accordance with the present invention may be prepared in any appropriate storage medium, such as a random access memory (RAM), a flash memory, a read-only memory (ROM), an EPROM, an EEPROM, a register, a hard disk drive (HDD), a removable disk, a CD-ROM, a database, a server, and the like.

The present application is based on and claims the benefit of priority of Japanese Patent Application No. 2015-034421, filed on Feb. 24, 2015, the entire contents of which are hereby incorporated by reference.

What is claimed is:

1. A communication device comprising:
a first communication unit configured to execute radio communication by using a first communication scheme, the first communication scheme allowing the radio communication to be executed within a first communication range;
a second communication unit configured to execute radio communication by using a second communication scheme, the second communication scheme allowing the radio communication to be executed within a second communication range;
a setting information retrieval unit configured to obtain, in response to detecting that the communication device is located within a predetermined area, setting information for establishing the radio communication by using the first communication scheme; and
a disconnection processing unit configured to disconnect radio communication that is established, by the first communication unit, with another communication device,
wherein the first communication unit is configured to execute, by using the first communication scheme, radio communication with the other communication device that obtains the setting information, and
wherein, upon detecting that the communication device is not located within the second communication range, the disconnection processing unit is configured to disconnect the radio communication that is established with the other communication device by the first communication unit.

2. The communication device according to claim 1,
wherein the setting information retrieval unit is configured to obtain the setting information by executing short range communication with an information processing device that covers the predetermined area.

3. The communication device according to claim 2,
wherein the short range communication is any one of Ultra Wide Band-based communication, visible light communication, and infrared communication.

4. The communication device according to claim 1,
wherein the setting information retrieval unit is configured to obtain the setting information based on sound waves that are transmitted by an information processing device that covers the predetermined area.

5. The communication device according to claim 1,
wherein the setting information retrieval unit is configured to obtain the setting information by capturing an image that is displayed by an information processing device.

6. The communication device according to claim 1,
wherein the setting information retrieval unit is configured to obtain the setting information by executing proximity communication with an information processing device that covers the predetermined area.

7. The communication device according to claim 1,
wherein the first communication range includes the second communication range.

8. A communication method to be executed by a communication device including a first communication unit configured to execute radio communication by using a first communication scheme, the first communication scheme allowing the radio communication to be executed within a first communication range; and a second communication unit configured to execute radio communication by using a second communication scheme, the second communication scheme allowing the radio communication to be executed within a second communication range, wherein the communication method comprises:
a step of obtaining, in response to detecting that the communication device is located within a predetermined area, setting information for establishing the radio communication by using the first communication scheme;
a step, by the first communication unit, of executing, by using the first communication scheme, radio communication with another communication device that receives the setting information; and
a step of disconnecting, upon detecting that the communication device is not located within the second communication range, the radio communication that is established with the other communication device by the first communication unit.
